(19) United States
(12) Patent Application Publication
(10) Pub. No.: US 2006/0060401 A1
(43) Pub. Date: Mar. 23, 2006

(54) Adjustable airflow regulator

(76) Inventor: Matthew M. Bole, Abbott, TX (US)

Correspondence Address: HARSHAW RESEARCH INCORPORATED, P O BOX 418, OTTAWA, KS, 66067, US

(21) Appl. No.: 10/946,482

(22) Filed: Sep. 21, 2004

(51) Int. Cl. B60K 11/00

(52) U.S. Cl. 180/68.1

(57) ABSTRACT

An airflow regulating device includes a first airflow regulator configured to replace a tractor truck's grille, means for adjusting the first airflow regulator between open and closed configurations, a second airflow regulator positioned inside a housing configured to attach atop the truck's cab, means for adjusting the second airflow regulator between open and closed configurations, and means for actuating each adjustment means. The second airflow regulator may embody either a multiple-louver or a nested-panel formation, and a proximity sensor is included in the means to actuate the adjustment means of the second airflow regulator. The first and second actuation means determine whether the first and second airflow regulators should be in the open or closed configurations and actuate the first and second adjustment means accordingly. The first and second adjustment means then adjust the first and second airflow regulators to the appropriate configurations, improving the truck's gas mileage.

### BACKGROUND OF THE INVENTION

This invention relates generally to an airflow regulator. In particular, the present invention relates to an adjustable airflow regulating device.

Many vehicles, and particularly large tractor trucks (also known as semi trucks) currently suffer from inefficiencies stemming from uncontrolled or imperfectly controlled airflow. If airflow over a truck is not deflected, the ensuing trailer will often create a large amount of drag. This unnecessarily reduces the truck's gas mileage. However, if the airflow over the truck is always deflected, the deflection creates an additional amount of drag that is unnecessary if a trailer is not being pulled.

Further, airflow over truck radiators is currently not regulated. While this may be appropriate for small vehicles which are primarily concerned about cooling, large trucks would benefit enormously by being able to control the airflow over their radiators. Especially at startup, much work is required for large truck engines to reach their operating temperatures. As a result, large trucks must spend considerable amounts of time warming up before being used, and many large truck drivers do not shut down their trucks when only stopped for short amounts of time. Not only does this warm up time needlessly extend the drivers' days, but it also reduces the trucks' gas mileage by burning fuel.

Various proposals addressing airflow regulators used in conjunction with automobiles are found in the art, including U.S. Pat. No. 3,854,459, U.S. Pat. No. 4,102,548, U.S. Pat. No. 4,534,506, U.S. Pat. No. 5,669,311, and U.S. Pat. No. 5,732,666.

While assumably effective for their intended purposes, none of the above proposals provide a device to be retrofitted onto a tractor truck that improves gas mileage as drastically by effectively regulating airflow that reaches the tractor truck.

### SUMMARY OF THE INVENTION

An airflow regulating device according to the present invention includes a first airflow regulator configured to replace a truck grille of a tractor truck, means for adjusting the first airflow regulator between an open grille configuration and a closed grille configuration, a second airflow regulator positioned inside a housing configured to attach atop a cab of the tractor truck, means for adjusting the second airflow regulator between an open top configuration and a closed top configuration, and means for actuating each adjustment means. The second airflow regulator may embody either a multiple-louver or a nested-panel formation, and a proximity sensor is included in the means to actuate the adjustment means of the second airflow regulator.

In use, the first actuation means determines whether the first airflow regulator should be in the open grille or closed grille configuration and actuates the first adjustment means accordingly. The first adjustment means then adjusts the first airflow regulator to the appropriate configuration. The second actuation means determines whether the second airflow regulator should be in the open top or closed top configuration and actuates the second adjustment means accordingly. The second adjustment means then adjusts the second airflow regulator to the appropriate configuration. By being in the appropriate configurations, the first and second airflow regulators effectively govern the airflow that reaches the tractor truck and improve the truck's gas mileage.

Therefore, a general object of this invention is to provide an adjustable airflow regulator that improves gas mileage for automobiles.

Another object of this invention is to provide an adjustable airflow regulator, as aforesaid, that may be retrofitted onto existing automobiles.

Still another object of this invention is to provide an adjustable airflow regulator, as aforesaid, that automatically adjusts to optimize airflow.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of an adjustable airflow regulator in a closed configuration according to one embodiment of the present invention that may replace a grille of a tractor truck;

FIG. 2a is a front perspective view of the adjustable airflow regulator as in FIG. 1 in an open grille configuration;

FIG. 2b is an isolated perspective view on an enlarged scale of the adjustment means taken from FIG. 2a;

FIG. 3a is a front perspective view of the adjustable airflow regulator as in FIG. 1 in an open grille configuration with adjustment means according to another embodiment of the present invention;

FIG. 3b is an isolated perspective view on an enlarged scale of the adjustment means taken from FIG. 3a;

FIG. 4a is a side view of the adjustable airflow regulator with the adjustment means as in FIG. 3a in an open grille configuration;

FIG. 4b is a side view of the adjustable airflow regulator with the adjustment means as in FIG. 3a in an open top configuration;

FIG. 4c is a side view of the adjustable airflow regulator with the adjustment means as in FIG. 3a in a closed configuration;

FIG. 5a is a front perspective view of the adjustable airflow regulator with the adjustment means as in FIG. 3a positioned inside a housing and in a closed configuration;

FIG. 5b is an exploded view of the adjustable airflow regulator and housing as in FIG. 5a;

FIG. 6a is a front perspective view of the adjustable airflow regulator as in FIG. 1 positioned inside a housing and in an open top configuration;

FIG. 6b is a rear perspective view of the adjustable airflow regulator as in FIG. 1 positioned inside a housing and in an open top configuration;

FIG. 6c is an isolated perspective view on an enlarged scale of the adjustment means taken from FIG. 6b;

FIG. 7a is a front view of the adjustable airflow regulator as in FIG. 1 positioned inside a housing and in an open top configuration;

FIG. 7b is a sectional view taken along line 7b-7b in FIG. 7a;

FIG. 8a is a front perspective view of an adjustable airflow regulator in a closed configuration according to still another embodiment of the present invention;

FIG. 8b is a rear perspective view of the adjustable airflow regulator as in FIG. 8a in a closed configuration;

FIG. 9a is a front perspective view of the adjustable airflow regulator as in FIG. 8a in an open top configuration;

FIG. 9b is a rear perspective view of the adjustable airflow regulator as in FIG. 8a in an open top configuration;

FIG. 10a is a front view of the adjustable airflow regulator as in FIG. 8a in an open top configuration;

FIG. 10b is a sectional view taken along line 10b-10b in FIG. 10a;

FIG. 10c is an isolated view on an enlarged scale of the inner panel and adjacent features taken from FIG. 10b;

FIG. 11a is a front view of the adjustable airflow regulator as in FIG. 8a in a closed top configuration;

FIG. 11b is a sectional view taken along line 11b-11b in FIG. 11a;

FIG. 11c is an isolated view on an enlarged scale of the inner panel and adjacent features taken from FIG. 11b;

FIG. 12a is a front view of the adjustable airflow regulator as in FIG. 8a in an open top configuration with adjustment means according to yet another embodiment of the present invention;

FIG. 12b is a sectional view taken along line 12b-12b in FIG. 12a;

FIG. 12c is a sectional view on an enlarged scale of the adjustment means as in FIG. 12b;

FIG. 13a is a front view of the adjustable airflow regulator as in FIG. 12a in a closed top configuration;

FIG. 13b is a sectional view taken along line 13b-13b in FIG. 13a;

FIG. 13c is a sectional view on an enlarged scale of the adjustment means as in FIG. 13b;

FIG. 14a is a block diagram showing the thermostat connected to the motor;

FIG. 14b is a block diagram showing the thermostat connected to the piston cylinder combination;

FIG. 15a is a block diagram showing the CPU connected to the proximity sensor and the motor;

FIG. 15b is a block diagram showing the CPU connected to the proximity sensor and the piston cylinder combination;

FIG. 16 is a block diagram showing the CPU connected to the means for adjusting the first airflow regulator and the means for adjusting the second airflow regulator; and

FIG. 17 is a block diagram showing the components of the airflow regulating device.

### DESCRIPTION OF THE PREFERRED EMBODIMENT

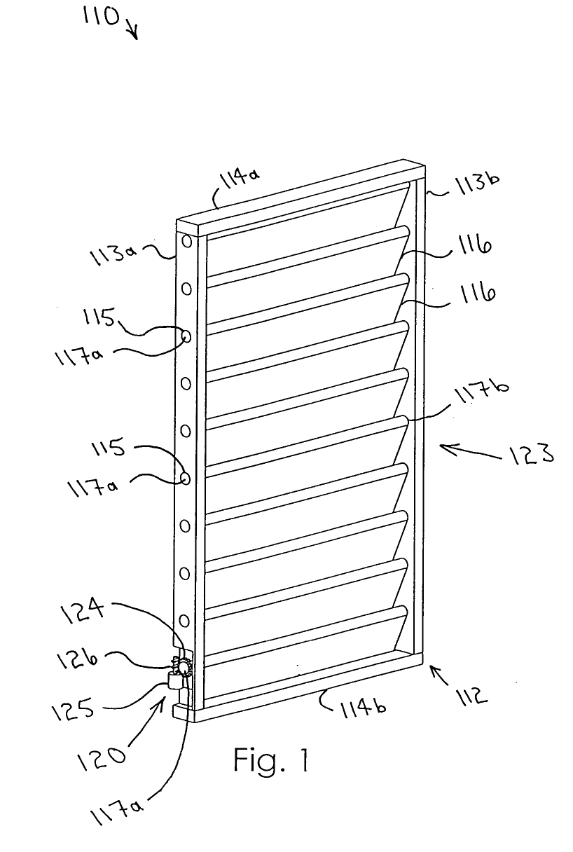

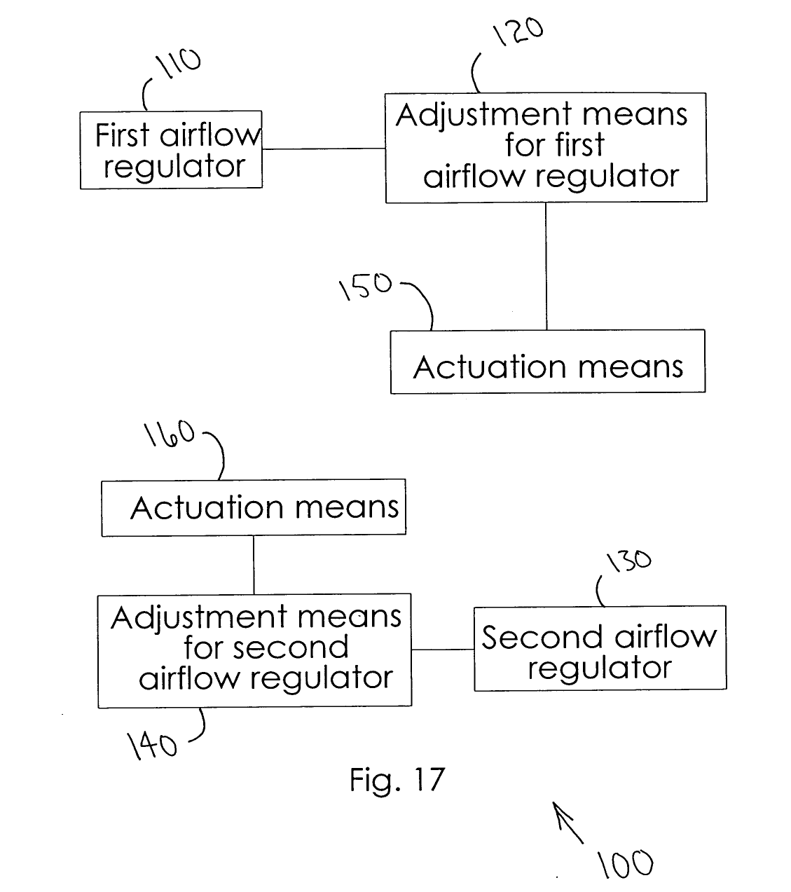

An airflow regulating device according to the present invention will now be described in detail with reference to FIGS. 1-2b, 5a-7b, 14a, 15a, and 17 of the accompanying drawings. More particularly, an airflow regulating device (also called a kit for improving gas mileage) 100 (FIG. 17) includes a first airflow regulator 110 configured to replace a truck grille of a tractor truck, means 120 for adjusting the first airflow regulator 110 between an open grille configuration 122 and a closed grille configuration 123, a second airflow regulator 130 positioned inside a housing 131 configured to attach atop a cab of the tractor truck, means 140 for adjusting the second airflow regulator 130 between an open top configuration 142 and a closed top configuration 143, and means 150, 160 for actuating the adjustment means 120, 140, respectively.

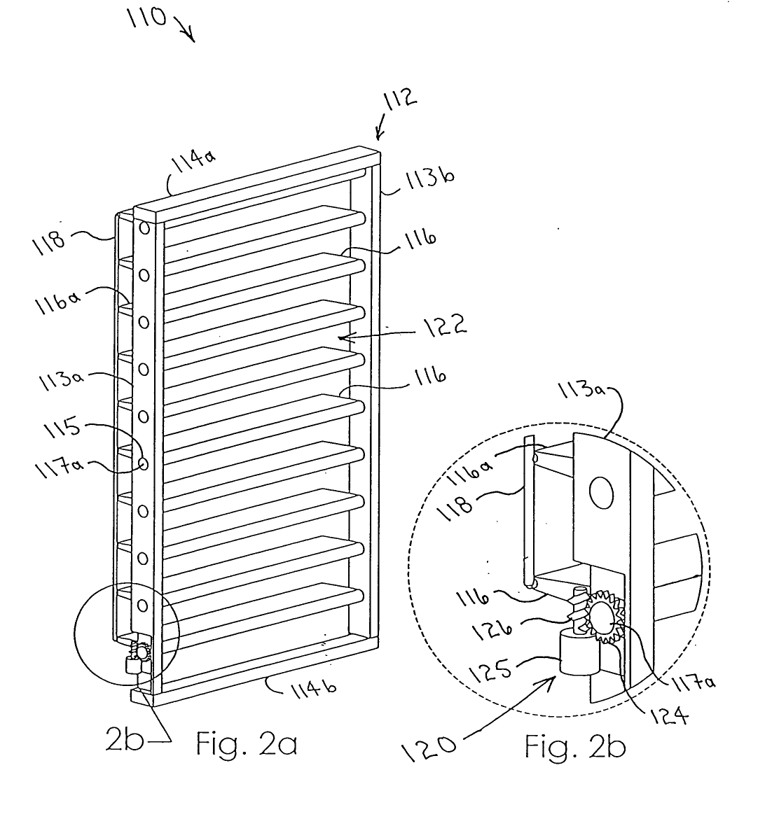

The first airflow regulator 110 includes a frame 112 and a plurality of louvers 116 (FIGS. 1 through 2b). The frame 112 has opposed left and right sidewalls 113a, 113b and opposed top and bottom sidewalls 114a, 114b extending between the left and right sidewalls 113a, 113b. The left and right sidewalls 113a, 113b each define a plurality of flange receptors 115. Each louver 116 extends between the left and right sidewalls 113a, 113b and has left and right hinge flanges 117a, 117b complementary to the respective flange receptors 115 of the left and right sidewalls 113a, 113b. A tie rod 118 is coupled to an outer edge 116a of each louver 116 for maintaining each louver 116 generally parallel to every other louver 116. The louvers 116 generally overlap one another when the first airflow regulator 110 is in the closed grille configuration 123 (FIG. 1), and each louver 116 is generally perpendicular to the left and right sidewalls 113a, 113b when the first airflow regulator 110 is in the open grille configuration 122 (FIG. 2a). It is to be understood that the louvers 116 may be positioned to provide the first airflow regulator 110 configurations intermediate the open grille and closed grille configurations 122, 123.

The adjustment means 120 includes a pinion gear 124, a motor 125, and a worm gear 126. The pinion gear 124 is operatively attached to a respective louver 116 for rotating the respective louver 116 about its left and right hinge flanges 117a, 117b. The motor 125 is mounted to the frame 112 proximate the pinion gear 124, and the worm gear 126 is operatively coupled to the motor 125. The worm gear 126 has a configuration complementary to a configuration of the pinion gear 124 for operative engagement therewith. When the motor 125 is energized, the worm gear 126 is operated, and the worm gear 126 in turn operates the pinion gear 124.

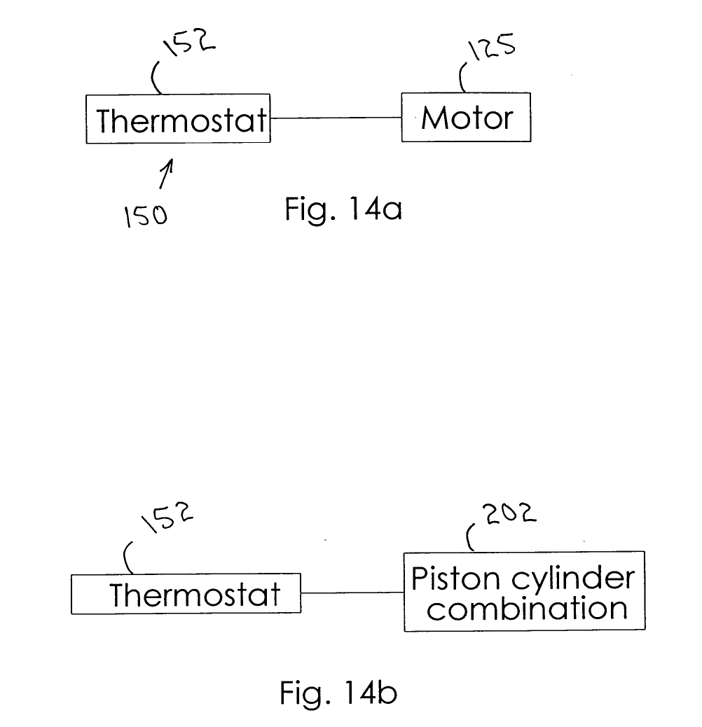

The means 150 for actuating the adjustment means 120 includes a thermostat 152 connected to the motor 125 as shown in FIG. 14a. When the engine cavity of the tractor truck reaches predetermined temperatures as determined by the thermostat 152, the thermostat 152 actuates the motor 125 to adjust the first airflow regulator 110 between the closed grille and open grille configurations 123, 122. By controlling the airflow that reaches the radiator of the tractor truck, the truck will be able to reach and maintain its operating temperature more efficiently. This reduces the amount of time needed for warming up the truck and allows the truck to be shut down when stopped for short amounts of time. As such, less fuel is consumed and gas mileage is improved.

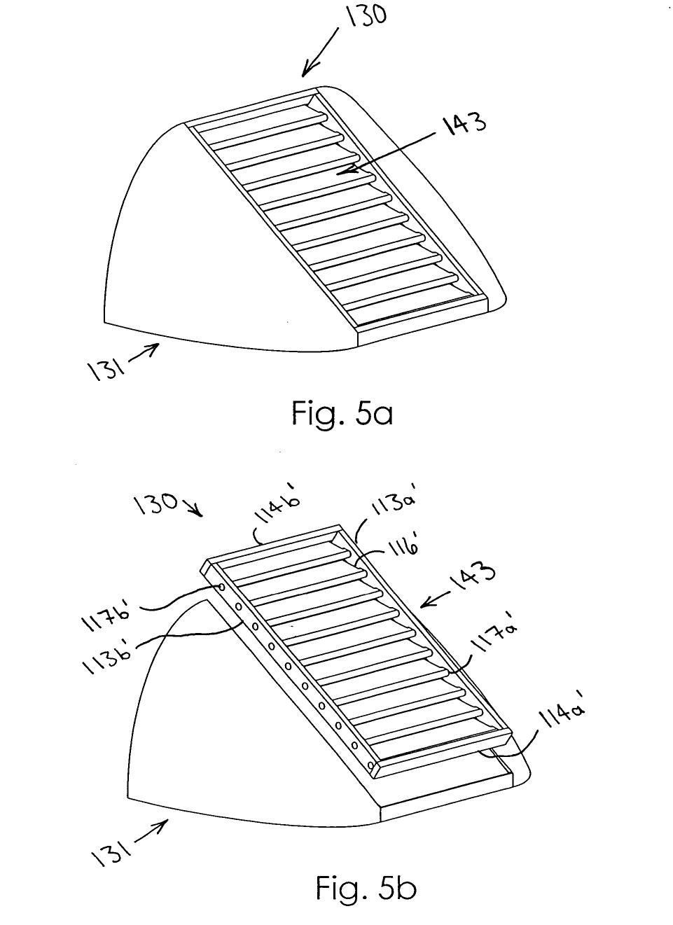

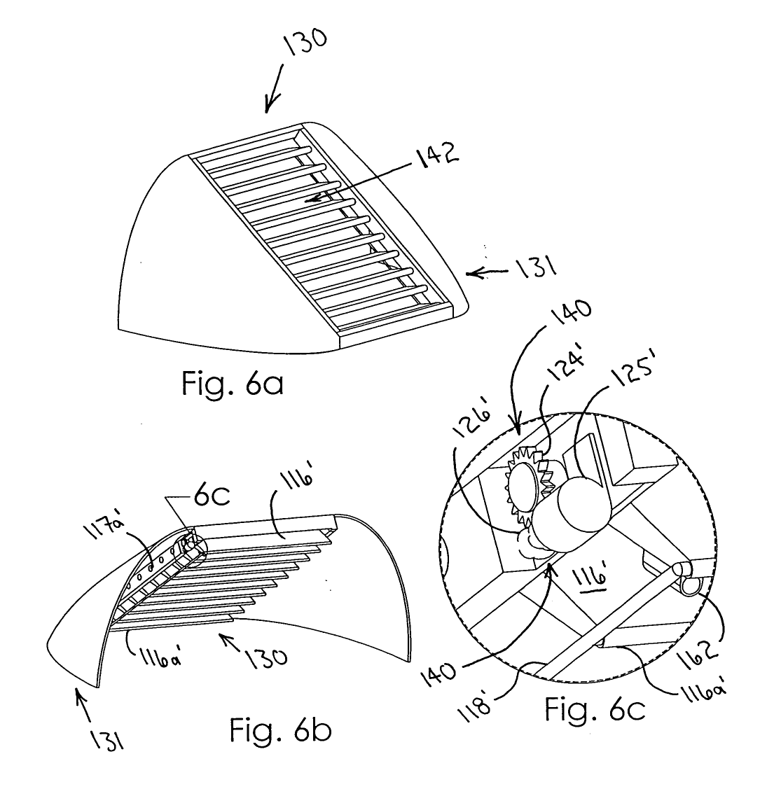

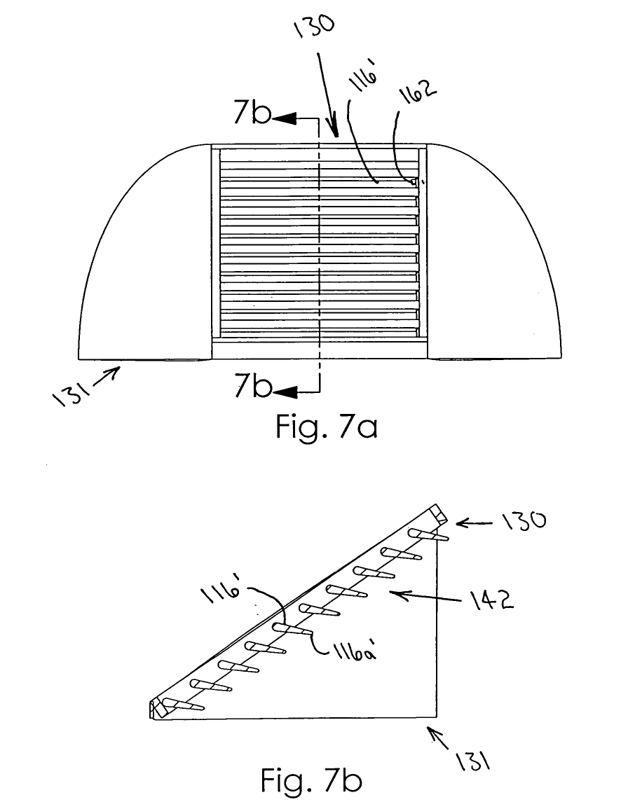

The second airflow regulator 130 and the means 140 for adjusting the second airflow regulator 130 (FIGS. 5a through 7b) include a construction substantially similar to the construction of the first airflow regulator 110 and the means 120 for adjusting the first airflow regulator 110 previously described, except as specifically noted below. Similar structure is denoted by prime numerals in the drawings. The louvers 116′ generally overlap one another when the second airflow regulator 130 is in the closed top configuration 143 (FIG. 5a), and each louver 116′ is generally horizontal when the second airflow regulator 130 is in the open top configuration 142 (FIGS. 6a and 7b).

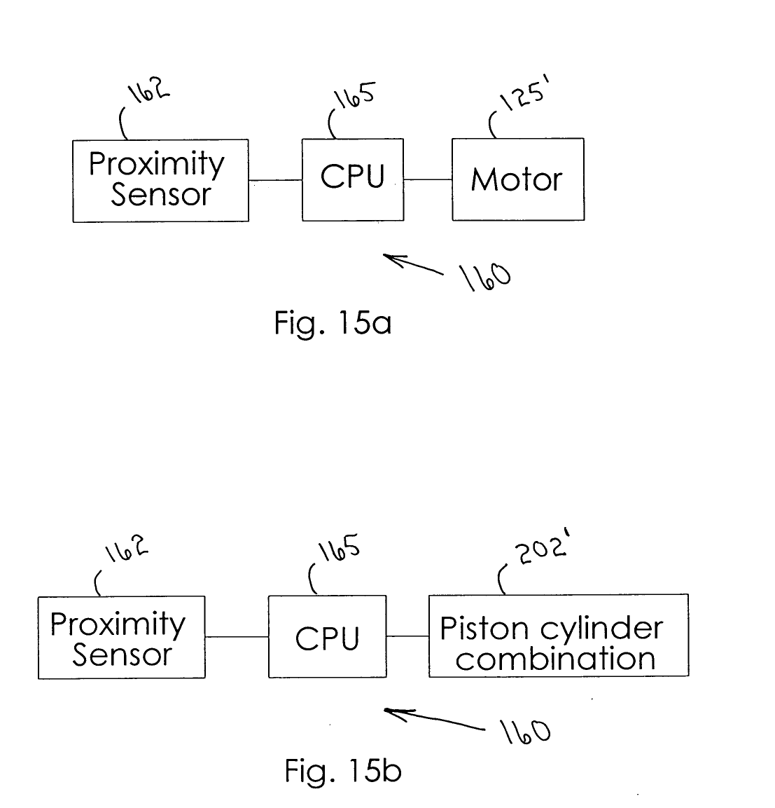

The means 160 for actuating the adjustment means 140 includes a CPU 165 operatively connected to a proximity sensor 162 (FIG. 6c) and the motor 125′ as shown in FIG. 15a. The proximity sensor 162 transmits signals and listens for replies (reflections from a trailer being pulled). If the proximity sensor 162 receives a reply, the CPU 165 actuates the motor 125′ to move the louvers 116′ toward the closed top configuration 143 and appropriately regulate the airflow. By regulating the airflow that would otherwise reach the trailer being pulled, the amount of drag is reduced and the gas mileage is improved. If the proximity sensor 162 does not receive a reply, the CPU 165 actuates the motor 125′ to move the louvers 116′ toward the open top configuration 142 and appropriately regulate the airflow. Thus, airflow is not restricted unnecessarily, which would needlessly increase the amount of drag and reduce the gas mileage.

In use, the first airflow regulator 110 is installed on a tractor truck, replacing the truck grille, and the second airflow regulator 130 and the housing 131 are attached atop the truck cab. The thermostat 152 actuates the motor 125 to change the configuration of the first airflow regulator 110 according to preset temperature parameters. When actuated, the motor 125 operates the worm gear 126, which then operates the pinion gear 124. The rotation of the pinion gear 124 rotates the attached louver 116 about its left and right hinge flanges 117a, 117b, and the tie rod 118 maintains each louver 116 generally parallel to every other louver 116 to cause all the louvers 116 to move substantially in unison. The proximity sensor 162 transmits signals and listens for replies. If the proximity sensor 162 receives a reply (a reflection from a trailer being pulled,) the CPU 165 actuates the motor 125′ to move the louvers 116′ toward the closed top configuration 143. If the proximity sensor 162 does not receive a reply, the CPU 165 actuates the motor 125′ to move the louvers 116′ toward the open top configuration 142. The means 140 for adjusting the second airflow regulator 130 include a construction substantially similar to adjusting means 120.

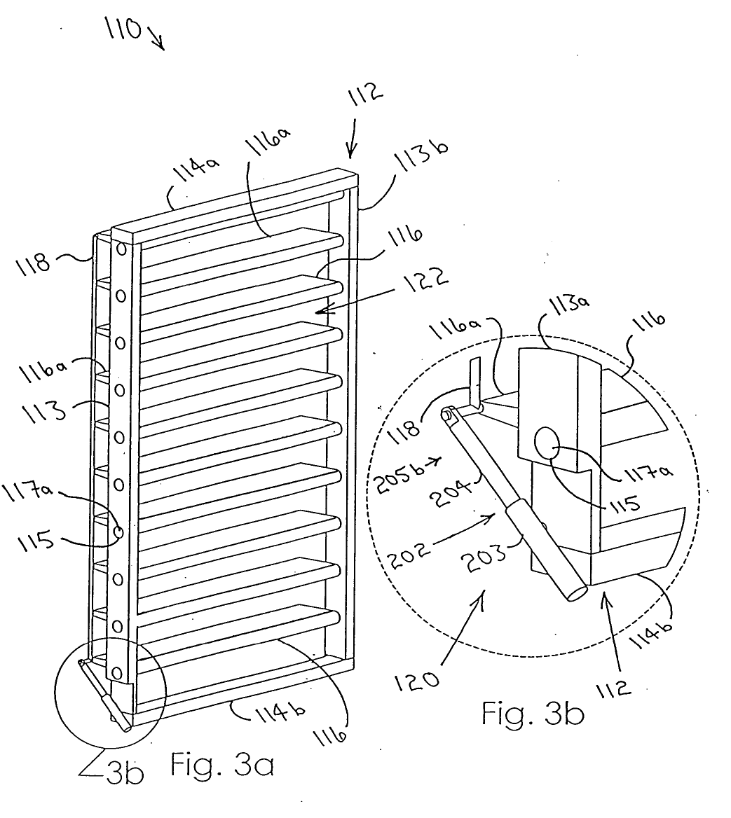

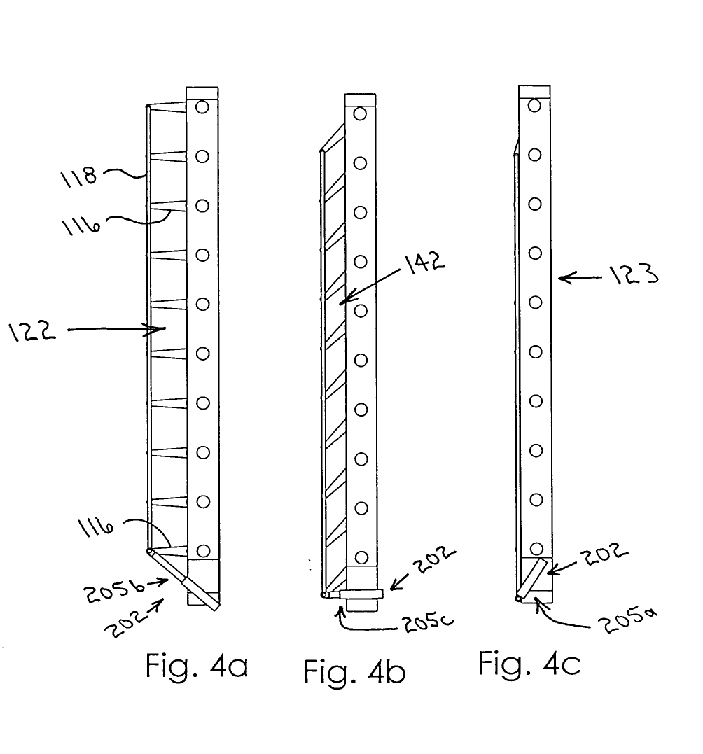

An airflow regulating device according to another embodiment of the present invention is shown in FIGS. 3a through 4c, 14b, and 15b and includes a construction substantially similar to the construction previously described except as specifically noted below. More particularly, the adjusting means 120 include a piston cylinder combination 202 having a cylinder 203 pivotally coupled to the frame 112 and a piston arm 204 extending from the cylinder 203 and pivotally coupled to a respective louver 116 for relative movement of the piston arm 204 between retracted and extended configurations 205a, 205b. The retracted configuration 205a corresponds to the closed grille configuration 123 (FIG. 4c), and the extended configuration 205b corresponds to the open grille configuration 122 (FIG. 4a). A partially extended configuration 205c corresponds to the open top configuration 142 (FIG. 4b), and adjusting means 140 may be substantially similar to the adjusting means 120 as described.

In use, the thermostat 152 actuates the piston cylinder combination 202 to change the configuration of the first airflow regulator 110 according to preset temperature parameters (FIG. 14b). When the piston cylinder combination 202 is actuated, the piston arm 204 extends or retracts to rotate the attached louver 116 about its left and right hinge flanges 117a, 117b. If the proximity sensor 162 receives a reply (a reflection from a trailer being pulled,) the CPU 165 actuates the piston cylinder combination 202′ (FIG. 15b), causing the piston arm 204′ to retract and move the louvers 116′ toward the closed top configuration 143. If the proximity sensor 162 does not receive a reply, the CPU 165 actuates the piston cylinder combination 202′, causing the piston arm 204′ to extend and move the louvers 116′ toward the open top configuration 142.

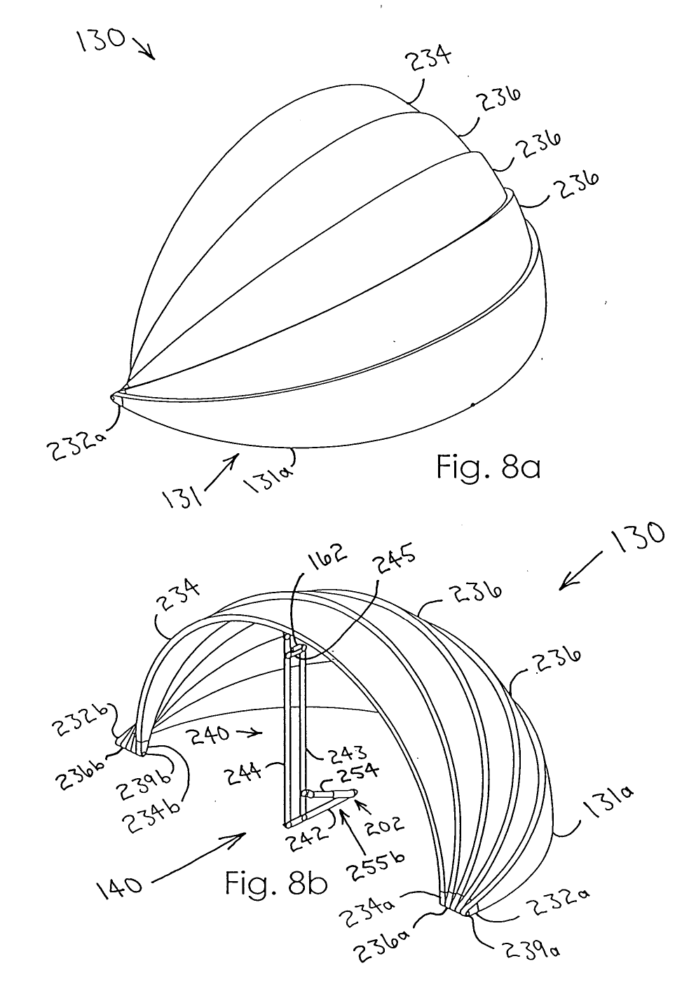

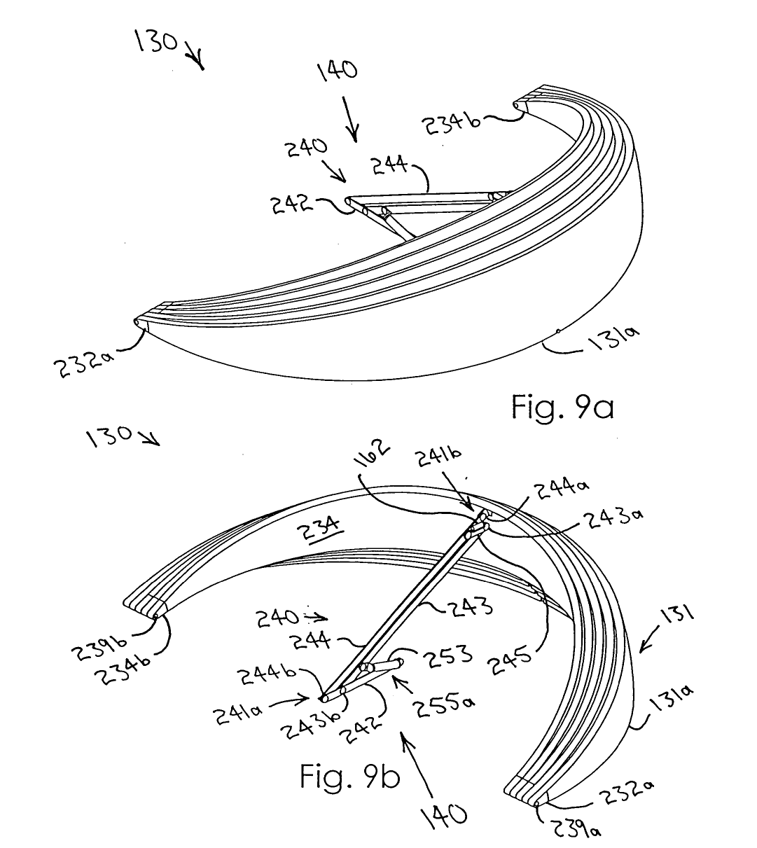

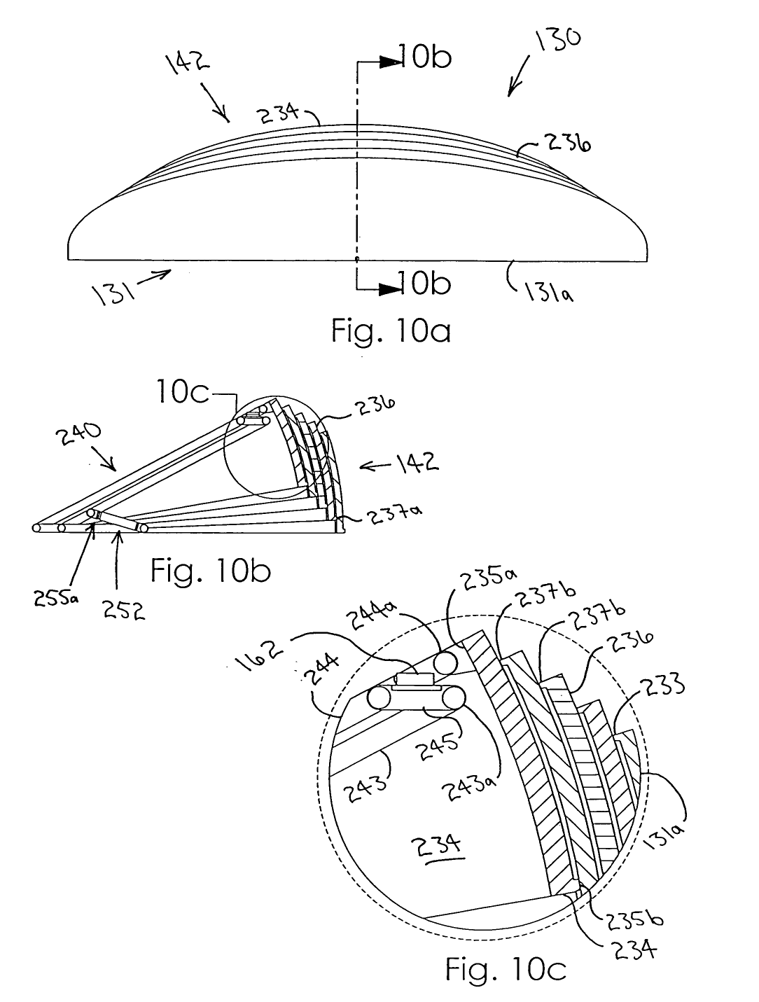

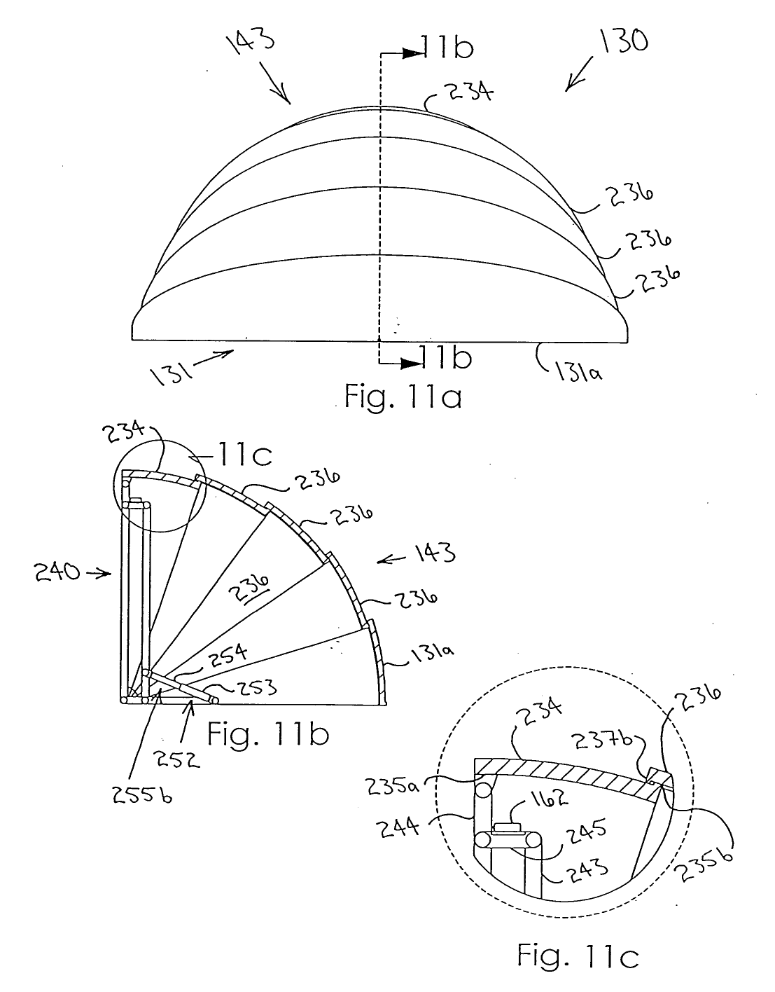

An airflow regulating device according to still another embodiment of the present invention is shown in FIGS. 8a through 11c and includes a construction substantially similar to the construction previously described except as specifically noted below. More particularly, the housing 131 includes a stationary outer panel 131a having first and second outer panel ends 232a, 232b and an inwardly turned forward edge 233 extending between the first and second outer panel ends 232a, 232b. The outer panel 131a has a generally arcuate configuration and is configured to attach atop the tractor truck cab.

The second airflow regulator 130 includes an inner panel 234 and a plurality of intermediate panels 236. The inner panel 234 has first and second inner panel ends 234a, 234b and a forward edge 235a and an outwardly turned rearward edge 235b extending between the first and second inner panel ends 234a, 234b. The inner panel 234 has a generally arcuate configuration. The intermediate panels 236 are nested within one another between the outer and inner panels 131a, 234, and each intermediate panel 236 has first and second intermediate panel ends 236a, 236b and a generally arcuate configuration. Each intermediate panel 236 further has an outwardly turned rearward edge 237a and an inwardly turned forward edge 237b extending between the first and second intermediate panel ends 236a, 236b. A first pin 239a couples the first outer panel end 232a to the first intermediate panel ends 236a and the first inner panel end 234a, and a second pin 239b couples the second outer panel end 232b to the second intermediate panel ends 236b and the second inner panel end 234b. The first and second pins 239a, 239b allow the inner and intermediate panels 234, 236 to selectively rotate about a common horizontal axis, and respective forward and rearward edges 237b, 237a of adjacent intermediate panels 236 engage one another upon the rotation of the inner and intermediate panels 234, 236.

The adjustment means 140 include a linkage 240 having a lower end 241a pivotally mounted atop the tractor truck cab and a second end 241b connected to the forward edge 235a of the inner panel 234. More particularly, the linkage 240 includes a stationary linkage base 242 mounted atop the tractor truck cab, a driven link 243 having top and bottom ends 243a, 243b, a traveling link 244 having top and bottom ends 244a, 244b, and a horizontal link 245. The bottom end 243b of the driven link 243 is pivotally attached to the linkage base 242 for angular movement of the driven link 243 relative to the linkage base 242. The bottom end 244b of the traveling link 244 is pivotally attached to the linkage base 242 for angular movement of the traveling link 244 relative to the linkage base 242. The top end 244a of the traveling link 244 is pivotally attached to the forward edge 235a of the inner panel 234 for causing the inner panel 234 to rotate when the traveling link 244 moves angularly relative to the linkage base 242. The horizontal link 245 is pivotally attached to the top end 243a of the driven link 243 and pivotally attached to the traveling link 244 for keeping the traveling link 244 approximately parallel to the driven link 243 at all times. The horizontal link 245 remains approximately horizontal at all times.

The adjustment means 140 further include a piston cylinder combination 252 having a cylinder 253 pivotally coupled to the tractor truck cab and a piston arm 254 selectively extending from the cylinder 253 in relative back and forth movement. The piston arm 254 is pivotally coupled to the linkage 240 for moving the linkage 240 and operating the second airflow regulator 130 between the open top configuration 142 when the piston arm 254 is at a retracted configuration 255a and the closed top configuration 143 when the piston arm 254 is at an extended configuration 255b.

The proximity sensor 162 is mounted on the horizontal link 245 for detecting the presence and height of a trailer behind the tractor truck, and the CPU 165 is connected to the proximity sensor 162 and the piston cylinder combination 252 for actuating the piston cylinder combination 252 when the proximity sensor 162 detects the trailer.

In use, the proximity sensor 162 transmits signals and listens for replies. If the proximity sensor 162 receives a reply, the CPU 165 actuates the piston cylinder combination 252, causing the piston arm 254 to extend and the second airflow regulator 130 to move toward the closed top configuration 143. The extending of the piston arm 254 causes the linkage 240 to rotate, and the rotation of the linkage 240 causes the inner panel 234 to rotate. When rotating, the inner panel 234 engages the adjacent intermediate panel 236, causing the intermediate panel 236 to rotate. If the proximity sensor 162 does not receive a reply, the CPU 165 actuates the piston cylinder combination 252, causing the piston arm 254 to retract and the second airflow regulator 130 to move toward the open top configuration 142. The retracting of the piston arm 254 causes the linkage 240 to rotate, and the rotation of the linkage 240 causes the inner panel 234 to rotate. When rotating, the inner panel 234 engages the adjacent intermediate panel 236, causing the intermediate panel 236 to rotate.

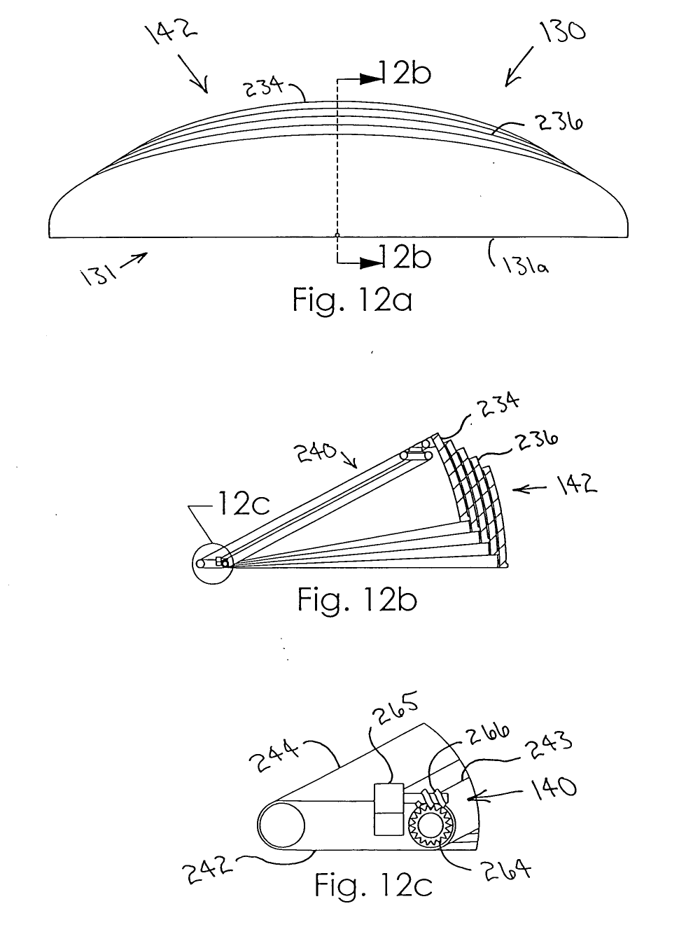

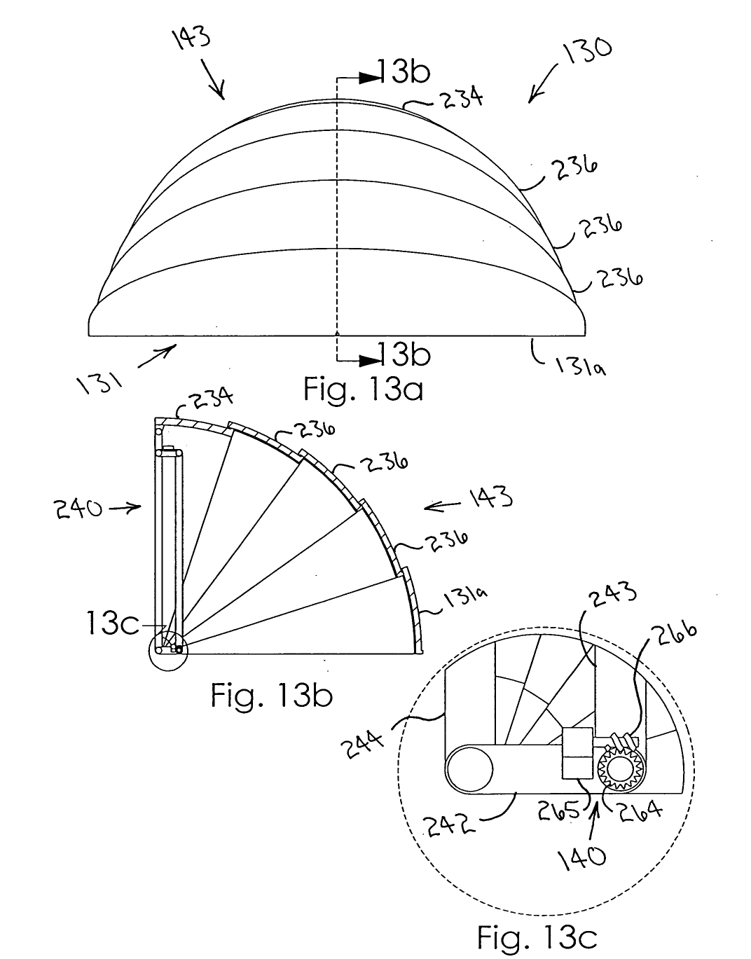

An airflow regulating device according to yet another embodiment of the present invention is shown in FIGS. 12a through 13c and includes a construction substantially similar to the construction previously described except as specifically noted below. More particularly, the adjustment means 140 of the second airflow regulator 130 include a pinion gear 264 operatively attached to the linkage 240, a motor 265 mounted to the stationary linkage base 242 proximate the pinion gear 264, and a worm gear 266 operatively coupled to the motor 265. The worm gear 266 has a configuration complementary to a configuration of the pinion gear 264 for operative engagement therewith, whereby the worm and pinion gears 266, 264 are operated when the motor 265 is energized.

In use, the proximity sensor 162 transmits signals and listens for replies. If the proximity sensor 162 receives a reply, the CPU 165 actuates the motor 265, causing the second airflow regulator 130 to move toward the closed top configuration 143. When the motor 265 is energized, the worm gear 266 is operated, and the worm gear 266 in turn operates the pinion gear 264. The rotation of the pinion gear 264 causes the attached linkage 240 to rotate, and the rotation of the linkage 240 causes the inner panel 234 to rotate. If the proximity sensor 162 does not receive a reply, the CPU 165 actuates the motor 265, causing the second airflow regulator 130 to move toward the open top configuration 142. When the motor 265 is energized, the worm gear 266 is operated, and the worm gear 266 in turn operates the pinion gear 264. The rotation of the pinion gear 264 causes the linkage 240 to rotate, and the rotation of the linkage 240 causes the inner panel 234 to rotate.

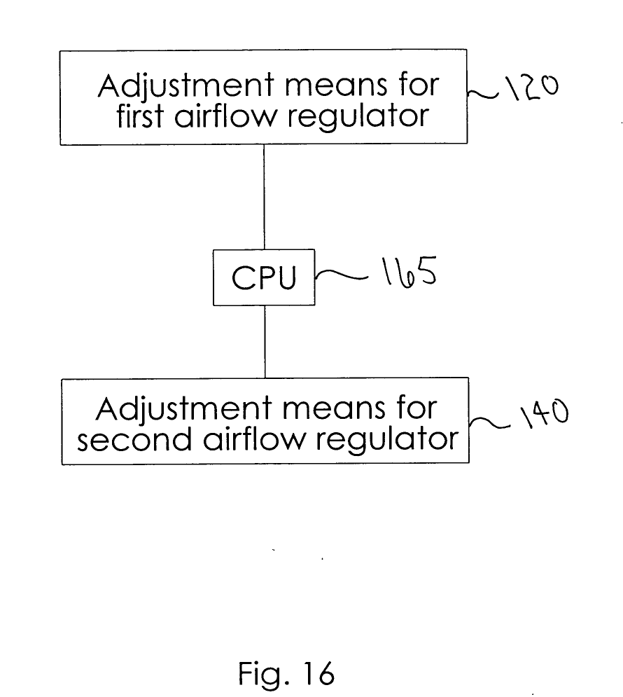

An airflow regulating device according to a further embodiment of the present invention is shown in FIG. 16 and includes a construction substantially similar to the construction previously described except as specifically noted below. More particularly, the actuation means 120, 160 for the first and second airflow regulators 110, 130 includes a single CPU 165. The CPU 165 receives fuel consumption data, velocity data, and temperature data from the vehicle and actuates adjustment of the first and second airflow regulators 110, 130 appropriately.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A kit for improving gas mileage configured for retrofitting onto a tractor truck, comprising:
a first airflow regulator configured to replace a truck grille of said tractor truck, said first airflow regulator including means for adjusting said first airflow regulator between an open grille configuration and a closed grille configuration;
a housing configured to attach atop a cab of said tractor truck;
a second airflow regulator positioned inside said housing, said second airflow regulator including means for adjusting said second airflow regulator between an open top configuration and a closed top configuration;
means for actuating said adjustment means of said first airflow regulator; and
means for actuating said adjustment means of said second airflow regulator.

2. The kit as in claim 1 wherein said first airflow regulator comprises:
a frame having opposed left and right sidewalls and opposed top and bottom sidewalls extending between said left and right sidewalls, each said left and right sidewall defining a plurality of flange receptors;
a plurality of louvers, each said louver extending between said left and right sidewalls, each said louver having left and right hinge flanges complementary to respective flange receptors of said left and right sidewalls, respectively; and
a tie rod pivotally coupled to an outer edge of each said louver for maintaining each said louver generally parallel to every other said louver, said plurality of louvers generally overlapping one another when said first airflow regulator is in said closed grille configuration, each said louver being generally perpendicular to said left and right sidewalls when said first airflow regulator is in said open grille configuration.

3. The kit as in claim 2 wherein said adjustment means of said first airflow regulator includes:
a pinion gear operatively attached to a respective louver for rotating said respective louver about said respective hinge flange;
a motor mounted to said frame proximate said pinion gear; and
a worm gear operatively coupled to said motor and having a configuration complementary to a configuration of said pinion gear for operative engagement therewith, whereby said worm and pinion gears are operated when said motor is energized.

4. The kit as in claim 2 wherein said adjustment means of said first airflow regulator includes a piston cylinder combination having a cylinder pivotally coupled to said frame and a piston arm extending from said cylinder and pivotally coupled to a respective louver for relative movement of said piston arm between retracted and extended configurations, said retracted configuration corresponding to said closed grille configuration, said extended configuration corresponding to said open grille configuration.

5. The kit as in claim 1 wherein said second airflow regulator comprises:
a frame having opposed left and right sidewalls and opposed top and bottom sidewalls extending between said left and right sidewalls, each said left and right sidewall defining a plurality of flange receptors;
a plurality of louvers, each said louver extending between said left and right sidewalls, each said louver having left and right hinge flanges complementary to respective flange receptors of said left and right sidewalls, respectively; and
a tie rod pivotally coupled to an outer edge of each said louver for maintaining each said louver generally parallel to every other said louver, said plurality of louvers generally overlapping one another when said second airflow regulator is in said closed top configuration, each said louver being generally horizontal when said second airflow regulator is in said open top configuration.

6. The kit as in claim 5 wherein said adjustment means of said second airflow regulator includes:
a pinion gear operatively attached to a respective louver for rotating said respective louver about said respective hinge flange;
a motor mounted to said frame proximate said pinion gear; and
a worm gear operatively coupled to said motor and having a configuration complementary to a configuration of said pinion gear for operative engagement therewith, whereby said worm and pinion gears are operated when said motor is energized.

7. The kit as in claim 5 wherein:
said adjustment means of said second airflow regulator includes a piston cylinder combination having a cylinder pivotally coupled to said frame and a piston arm extending from said cylinder and pivotally coupled to a respective louver for relative movement of said piston arm between retracted and extended configurations;
said second airflow regulator is at said closed top configuration when said piston arm is at said retracted configuration and said second airflow regulator is at said open top configuration when said piston arm is at said extended configuration; and
movement of said piston arm causes said respective louver to rotate about said left and right hinge flanges.

8. The kit as in claim 1 wherein said housing includes a stationary outer panel having first and second outer panel ends and an inwardly turned forward edge extending between said first and second outer panel ends, said outer panel having a generally arcuate configuration, and wherein said second airflow regulator includes:
an inner panel having first and second inner panel ends and a forward edge and an outwardly turned rearward edge extending between said first and second inner panel ends, said inner panel having a generally arcuate configuration;
a plurality of intermediate panels nested within one another between said outer and inner panels, each intermediate panel having first and second intermediate panel ends and a generally arcuate configuration, each intermediate panel having an outwardly turned rearward edge and an inwardly turned forward edge extending between said first and second intermediate panel ends;
means for coupling said first and second ends of said inner and intermediate panels to said housing, respectively, such that said inner and intermediate panels selectively rotate about a common horizontal axis; and
wherein respective forward and rearward edges of adjacent intermediate panels engage one another upon rotation of said inner and intermediate panels.

9. The kit as in claim 8 wherein said adjustment means of said second airflow regulator includes:
a linkage having a lower end pivotally mounted atop said tractor truck cab and a second end connected to said forward edge of said inner panel; and
a piston cylinder combination having a cylinder pivotally coupled to said tractor truck cab and a piston selectively extending from said cylinder in relative back and forth movement, said piston being pivotally connected to said linkage for moving said linkage and operating said second airflow regulator between said open top configuration when said piston is at said retracted configuration and said closed top configuration when said piston is at said extended configuration.

10. The kit as in claim 9 wherein said linkage includes:
a stationary linkage base mounted atop said tractor truck cab;
a driven link having top and bottom ends, said bottom end of said driven link being pivotally attached to said linkage base for angular movement of said driven link relative to said linkage base;
a traveling link having top and bottom ends, said bottom end of said traveling link being pivotally attached to said linkage base for angular movement of said traveling link relative to said linkage base, said top end of said traveling link being pivotally attached to said forward edge of said inner panel for causing said inner panel to rotate about said common horizontal axis when said traveling link moves angularly relative to said linkage base; and
a horizontal link pivotally attached to said top end of said driven link and pivotally attached to said traveling link for keeping said traveling link approximately parallel to said driven link at all times, whereby said horizontal link remains approximately horizontal at all times.

11. The kit as in claim 10 wherein said actuation means of said second airflow regulator includes:
a proximity sensor mounted on said horizontal link for detecting the presence and height of a trailer behind said tractor truck; and
a CPU connected to said proximity sensor and said piston cylinder combination for actuating said piston cylinder combination when said proximity sensor detects said trailer.

12. The kit as in claim 8 wherein said adjustment means of said second airflow regulator includes:
a linkage having a lower end pivotally mounted atop said tractor truck cab and a second end connected to said forward edge of said inner panel;
a pinion gear operatively attached to said linkage;
a motor mounted to a stationary portion of said linkage proximate said pinion gear; and
a worm gear operatively coupled to said motor and having a configuration complementary to a configuration of said pinion gear for operative engagement therewith, whereby said worm and pinion gears are operated when said motor is energized.

13. The kit as in claim 1 wherein said actuation means of said first airflow regulator and said actuation means of said second airflow regulator includes a CPU receiving fuel consumption data, velocity data, and temperature data.

14. An airflow regulating device, comprising:
a housing configured to attach atop a cab of said tractor truck;
a frame positioned in said housing and having opposed left and right sidewalls and opposed top and bottom sidewalls extending between said left and right sidewalls, each said left and right sidewall defining a plurality of flange receptors;
a plurality of louvers, each said louver extending between said left and right sidewalls, each said louver having left and right hinge flanges complementary to respective flange receptors of said left and right sidewalls, respectively;
means to adjust said airflow regulator between an open top configuration and a closed top configuration; and
means to actuate said adjustment means.

15. The airflow regulating device as in claim 14 wherein said actuation means includes:
a proximity sensor mounted on a said louver for detecting the presence and height of a trailer behind said tractor truck; and
a CPU connected to said proximity sensor and said adjustment means for actuating said adjustment means when said proximity sensor detects said trailer.

16. An airflow regulating device, comprising:
a stationary outer panel having first and second outer panel ends and an inwardly turned forward edge extending between said first and second outer panel ends, said outer panel having a generally arcuate configuration and being configured to attach atop a cab of a tractor truck;
an inner panel having first and second inner panel ends and a forward edge and an outwardly turned rearward edge extending between said first and second inner panel ends, said inner panel having a generally arcuate configuration;
a plurality of intermediate panels nested within one another between said outer and inner panels, each intermediate panel having first and second intermediate panel ends and a generally arcuate configuration, each intermediate panel having an outwardly turned rearward edge and an inwardly turned forward edge extending between said first and second intermediate panel ends;
means for coupling said first and second ends of said inner and intermediate panels to said outer panel, respectively, such that said inner and intermediate panels selectively rotate about a common horizontal axis, and wherein respective forward and rearward edges of adjacent intermediate panels engage one another upon said rotation of said inner and intermediate panels;
means to adjust said inner and intermediate arcuate panels between an open top configuration and a closed top configuration; and
means to actuate said adjustment means.

17. The airflow regulating device as in claim 16 wherein said adjustment means includes:
a linkage having a lower end pivotally mounted atop said tractor truck cab and a second end connected to said forward edge of said inner panel; and
a piston cylinder combination having a cylinder pivotally coupled to said tractor truck cab and a piston selectively extending from said cylinder in relative back and forth movement, said piston being pivotally connected to said linkage for moving said linkage and operating said airflow regulator between said open top configuration when said piston is at said retracted configuration and said closed top configuration when said piston is at said extended configuration.

18. The airflow regulating device as in claim 17 wherein said actuation means includes:
a proximity sensor mounted on said linkage for detecting the presence and height of a trailer behind said tractor truck; and
a CPU connected to said proximity sensor and said piston cylinder combination for actuating said piston cylinder combination when said proximity sensor detects said trailer.

19. The airflow regulating device as in claim 16 wherein said adjustment means includes:
a linkage having a lower end pivotally mounted atop said tractor truck cab and a second end connected to said forward edge of said inner panel;
a pinion gear operatively attached to said linkage;
a motor mounted to a stationary portion of said linkage proximate said pinion gear; and
a worm gear operatively coupled to said motor and having a configuration complementary to a configuration of said pinion gear for operative engagement therewith, whereby said worm and pinion gears are operated when said motor is energized.

20. The airflow regulating device as in claim 19 wherein said actuation means includes:
a proximity sensor mounted on said linkage for detecting the presence and height of a trailer behind said tractor truck; and
a CPU connected to said proximity sensor and said motor for actuating said motor when said proximity sensor detects said trailer.
